(19) United States
(12) Patent Application Publication
(10) Pub. No.: US 2023/0382032 A1
(43) Pub. Date: Nov. 30, 2023

(54) METHOD AND APPARATUS FOR INJECTION-COMPRESSION MOLDING

(71) Applicant: Arris Composites Inc., Berkeley, CA (US)

(72) Inventors: Sam PIRAHANCHI, Novato, CA (US); Erick DAVIDSON, Piedmont, CA (US)

(21) Appl. No.: 18/201,503

(22) Filed: May 24, 2023

Related U.S. Application Data
(60) Provisional application No. 63/345,203, filed on May 24, 2022.

(51) Int. Cl. B29C 45/56; B29C 45/14

(52) U.S. Cl. CPC B29C 45/561; B29C 45/14631

(57) ABSTRACT

In an injection/compression-molding process, an assemblage of fiber-bundle-based preforms are placed in a mold cavity of a mold tool. The mold is then fully closed, but not pressurized. An injection charge, which includes resin and optionally short fibers, is placed in a plunger cavity that is in fluidic communication with the mold cavity. The injection charge is liquefied and injected into the mold cavity, pressurizing it to a pressure suitable for compression molding. If not previously liquefied, the resin in fiber-bundle-based preform is liquefied and, under the applied pressure, the resins and fibers are consolidated and then cooled to form a part.

### STATEMENT OF RELATED CASES

This case claims priority of U.S. Pat. No. 63/345,203 filed May 24, 2022, and which is incorporated herein by reference.

### FIELD OF THE INVENTION

The present invention relates to methods and apparatuses for molding fiber-reinforced composite parts.

### BACKGROUND OF THE INVENTION

Composite materials, which have fibers embedded in a supporting matrix material, are used for fabricating strong yet lightweight parts. These composites have an attractive combination of properties, and provide significant manufacturing, performance, and economic advantages compared to metal-based counterparts.

Applicant has disclosed the use of an assemblage of fiber-bundle-based preforms as a feed constituent for a compression-molding process. Each such preform is a bundle of resin-impregnated fibers, which is typically sourced from towpreg, or the output from a resin-impregnation line. In addition to being cut to a desired size, the preform is usually specifically shaped to fit the contours of a mold in which it is to be placed and/or to provide a desired fiber alignment at a discrete region of the mold.

The use of fiber-bundle-based preforms as a feed constituent provides benefits over the use of more conventional composite feed constituents, such as those in the form of chopped fiber, tape/ribbon, sheets, or laminates. Fiber-bundle-based preforms provide an ability to tailor, with great specificity, the alignment of fibers within a part. Consequently, applicant's approach provides an unprecedented ability to align fibers with the stress vectors that are expected to arise in the finished part when in use. This enables the fabrication of parts having superior mechanical properties for particular use cases.

But difficulties can arise from the use of fiber-bundle-based preforms in a compression-molding process. For example, when creating parts having especially thin or complex features, it can be problematic to achieve a desired fiber alignment. And fibers may clump when filling such thin mold/complex mold features, resulting in “dry” areas that are devoid of resin.

Another problematic issue with compression-molding processes is tool wear. Such wear results, primarily, from relative motion between metal mold-tool surfaces as the feed constituents are compressed.

The gaps between tool surfaces cannot be increased to reduce the metal-on-metal wear because that would permit an excessive amount of liquified resin and fibers to flow into such enlarged gaps. Material that leaks into these gaps solidifies to form “flash” when processing temperature is lowered. Flash reduces the consistency of demolded parts, can prevent the part from functioning as intended, makes parts difficult or irritating to handle, and negatively impacts part cosmetics. Flash must be removed from the part before use, thereby increasing manufacturing time, complexity, and cost. But decreasing the size of the tool gaps increases the cost of a mold (due to the precision machining required for the tighter tolerances), increases the time it takes to fabricate a mold, and increases the likelihood of errors in tool tolerance and parallelism, wherein such errors will result in binding, galling, and other guide issues. Although coatings on the tool walls can prevent or reduce damage, these are costly and can interfere with maintenance on the mold.

Although tool wear is not unique to applicant's use of fiber-bundle-based preforms, the presence of relatively long fibers in the mold, whether from applicant's preforms or feed constituents having other form factors, may exacerbate tool wear. Because these long fibers move minimally once positioned in a mold cavity, their interaction with moving mold surfaces causes abrasion of those surfaces.

### SUMMARY

The present invention avoids some of the costs and disadvantages of prior compression-molding processes.

Some embodiments of the invention provide a modified compression-molding process and apparatus. In accordance with the illustrative embodiment, and unlike prior compression-molding processes, the volume of feed constituents placed in the mold cavity is insufficient to fill it. The volume of the feed constituents is no more than 99 percent of the volume of the closed mold cavity, and more typically in the range of 25 to 95 percent of the volume of the closed mold cavity, and most typically in the range of about 50 to 90 percent of it. In the case of applicant's compression-molding processes, those feed constituents are typically an assemblage of fiber-bundle-based preforms. The assemblage of preforms may be a “preform charge,” wherein the preforms are tacked together, typically in advance of being placed in the mold cavity. Alternatively, the assemblage can be a loose (unbound) arrangement of preforms that is organized as a “lay-up” in the mold cavity.

With the assemblage of preforms in the mold cavity, a press is then actuated to close the mold. A substantial amount of force is applied to bring the two mold halves together so that gaps between abutting mold surfaces are reduced to a practical minimum. Relatively minimal or no (excess) pressure is borne by the feed constituents at this point in the process due to their less-than-mold-filling volume. Rather, the pressure is borne by the mold tool, itself. The closing force, which can result in a pressure on the mold tool that is an order of magnitude greater than that applied to the feed constituents later in the process, cannot exceed the yield strength of the steel, etc., that forms the mold.

In accordance with the present teachings, in addition to the assemblage of preforms positioned in the mold cavity, a separate charge of neat resin (i.e., resin only—no fibers) or resin with fibers that are typically less than about 25 millimeters in length, is situated in one or more plunger cavities. The one or more plunger cavities may reside in one of the mold portions (typically the male portion). The plunger cavity is external to the mold cavity, but it is in fluidic communication therewith. The separate charge(s) of molding constituents is referred to herein as an “injection charge(s).”

After the mold is tightly closed, and while the injection charge(s) are in the plunger cavity or cavities, the temperature of at least the injection charge is raised sufficiently for its resin to achieve the melt-flow state. Once the melt-flow state is reached, the injection charge(s) is injected (via one or more plungers) through the one or more plunger cavities, into the mold cavity. This extra charge fills the remaining volume of the mold cavity and pressurizes all the molding constituents.

In some embodiments, the resin in the assemblage of preforms is brought to its melt-flow state before the injection charge is introduced into the mold cavity. In some other embodiments, the resin in the assemblage of preforms is brought to its melt-flow state during introduction of the injection charge. That is, the assemblage is heated to a temperature near to, but below, its melt temperature prior to introduction of the injection charge. Upon introduction of the injection charge into the mold cavity, the assemblage is heated to its melt flow state via the injection charge. This enables optimizing the process cycle time, providing a short-as-possible cooling time.

The pressure applied by the injection charge, which is typically in the range of about 1000 to 5000 psi, ensures that all molding constituents in the mold cavity are fully consolidated. Subject to the limitation regarding the yield strength of the steel forming the mold, the mold is closed with a force that results in a pressure on the mold tool that is substantially higher than that of the charge-injection pressure; that is, much greater than 5000 psi.

It is notable that in applicant's existing compression-molding processes, the volume of the assemblage of preforms is greater than the cavity volume of the fully closed mold, the latter volume defining the part's volume and geometry. This is primarily due to the form factor of the preforms (i.e., circular/oval cross section), which prevents them from tightly packing to one another. In fact, the volume of the assemblage is typically consolidated during processing by an amount in the range of 20 to 300 percent. So, if the volume of the assemblage of preforms (which is not consolidated) were not greater than the final part volume, there would be insufficient material present to fill the fully closed mold cavity during the consolidation phase of the process. As such, the height of at least some portion the assemblage is greater than the height of the fully closed mold cavity (and that of the finished part). Consequently, in applicant's existing processes and unlike embodiments of the present invention, pressure is applied to the assemblage of preforms before the mold fully closes. Typically, a press is actuated to force the male mold portion toward the female mold portion. A feature (e.g., a plunger, etc.) extending from the male mold portion engages the top of the assemblage. With continued downward force, as applied by the press, the (liquefied) assemblage is consolidated. At some point, the mold fully closes. At that point, no further pressure can be applied to the assemblage. It is not possible to prevent the flow of liquefied resin and fiber into the gap between mold surfaces prior to full closure of the mold.

The existing process contrasts with embodiments in accordance the present teachings, wherein the volume of the assemblage of preforms is less than the cavity volume of the fully closed mold. Moreover, the height of the assemblage of preforms is less than the height of the mold cavity of the fully closed mold. No feature of the male mold portion engages the assemblage to compress it. Rather, the assemblage is pressurized only by the injection charge that is introduced into the mold cavity. And this pressurization occurs only after the mold tool is fully closed. This approach substantially ameliorates the problem of liquefied resin and fibers flowing into the gaps between mold surfaces, as discussed above.

Thus, embodiments of the invention involve: (i) an initial placement of an assemblage of preforms having a less-than-mold-filling volume, followed by (ii) injection of neat resin or resin having short fibers (<25 millimeters) at a pressure sufficient for consolidation of all molding constituents.

Quite unexpectedly, regardless of when the resin in the assemblage of preforms achieves its melt-flow state, the injection charge (having no fiber or relatively shorter fibers than the assemblage of preforms) tends to flow around the outside/periphery of the assemblage of preforms. Consequently, there is a substantially reduced tendency for the relatively longer fibers of the assemblage to interact with the moving mold surfaces.

In addition to fabricating finished parts with a highly desirable fiber alignment (per the initial placement of fiber-bundle-based preforms), embodiments of the invention provide the following benefits, among any others:
reduced tool wear;
reduced flash due to the very high-pressure contact at the parting surfaces between mold sections, which reduces post-processing operations; and
a high-quality finish to part surfaces since the after-injected neat resin or resin mixed with very short fibers tends to remain near the surface of the finished part.

Some embodiments of the invention provide an injection/compression-molding method for forming a part, the method comprising:
placing an assemblage of fiber-bundle-based preforms in a mold cavity of a female mold portion of a mold tool, each fiber-bundle-based preform consisting essentially of a first resin and a plurality of fibers, wherein a volume of the assemblage is less than a volume of the mold cavity when the mold tool is fully closed, a void volume therefore remaining, and wherein a height of the assemblage is no greater than a height of the cavity of the fully closed mold tool;
placing an injection charge in a first plunger cavity that is in fluidic communication with the mold cavity, the injection charge consisting essentially of a second resin with or without fibers, wherein any fibers in the injection charge are less than about 25 millimeters in length and less than a length of the fibers in the fiber-bundle-based preforms;
closing the mold cavity, thereby placing a male mold portion and the female mold portion into abutting relation;
liquefying the second resin;
introducing the injection charge into the mold cavity by advancing a first plunger in the first plunger cavity, the injection charge filling the void volume, thereby pressurizing the mold cavity, wherein the mold cavity is pressurized to a pressure suitable for compression molding;
liquefying the first resin, wherein the pressure applied by the injection charge consolidates the first resin, the second resin, the plurality of fibers from the fiber-bundle-based preforms, and the fibers, if present, from the injection charge, collectively referenced as the “molding constituents”; and after a period of time, cooling the consolidated molding constituents to form the part.

Some other embodiments of the invention provide an injection/compression-molding method for forming a part, the method comprising:
closing, but not pressurizing, a mold that contains, in a mold cavity, an assemblage of fiber-bundle-based preforms, each preform comprising a first resin and a plurality of fibers, wherein a volume of the assemblage is less than a volume of the mold cavity when the mold tool is fully closed, a void volume therefore remaining, and wherein a height of the assemblage is no greater than a height of the cavity of the fully closed mold tool;
liquefying an injection charge that is disposed in a first plunger cavity that is in fluidic communication with the mold cavity, the injection charge comprising a second resin;
pressurizing the mold cavity to a pressure suitable for compression molding by introducing the liquefied injection charge into the mold cavity;
liquefying the first resin and consolidating the first resin, the second resin, and the plurality of fibers via the pressure applied by the injection charge; and
after a period of time, cooling and depressurizing to form the part.

### BRIEF DESCRIPTION OF THE DRAWINGS

FIG. 1A depicts a top view of the female portion or “b-side” of a compression molding tool in accordance with the present teachings.

FIG. 1B depicts a plan view of the male portion or “a-side” of a compression molding tool in accordance with the present teachings.

FIG. 1C depicts a cross-sectional view along the line A-A, in the direction indicated, for the assembled mold comprising the female and male mold portions depicted in respective FIGS. 1A and 1B.

FIG. 2A depicts an assemblage of preforms disposed in the mold cavity of the female portion of the compression molding tool, as depicted in FIG. 1A.

FIG. 2B depicts the view of compression mold shown in FIG. 1C, including the assemblage of preforms in the mold cavity and an injection charge in the plunger cavity, in accordance with the present teachings.

FIG. 2C depicts an enlargement of the mold cavity of FIG. 2B, showing the path of liquefied injection charge through the mold cavity.

FIG. 3A depicts a top view of the female portion of a compression molding tool including plural plunger cavities

FIG. 3B depicts a cross-sectional view of a closed mold consistent with the female portion of the mold depicted in FIG. 3A, and showing injection charge.

FIGS. 4A and 4B depict different plunger cavity geometries.

FIG. 5 depicts a complex mold cavity and assemblage of preforms.

FIGS. 6A-6C depict a method for altering the shape of preforms/fibers using injection charge in accordance with the illustrative embodiment of the invention.

### DETAILED DESCRIPTION

### Definitions

The following terms are defined for use in this description and the appended claims:
“Fiber” means an individual strand of material. A fiber has a length that is much greater than its diameter.
“Fiber bundle” means plural (typically multiples of one thousand) co-aligned fibers.
“Stiffness” in the context of a material means resistance to bending, as measured by Young's modulus. When used in the context of a spring or spring assembly, “stiffness” means resistance to displacement from an unstretched/uncompressed state.
“Tow” means a bundle of fibers (i.e., fiber bundle), and those terms are used interchangeably herein unless otherwise specified. Tows are typically available with fibers numbering in the thousands: a 1K tow (1000 fibers), 4K tow (4000 fibers), 8K tow, etc.
“Prepreg” means fibers that are impregnated with resin.
“Towpreg” means a fiber bundle (i.e., a tow) that is impregnated with resin.
“Preform” means a segment of plural, co-aligned, resin-impregnated, typically same-length fibers. The segment is cut to a specific length, and, in many cases, will be shaped (e.g., bent, twisted, etc.) to a specific form, as appropriate for the specific part being molded. Preforms are usually sourced from towpreg (i.e., the towpreg is sectioned to a desired length), but can also be from another source of plural co-aligned, unidirectionally aligned fibers (e.g., from a resin impregnation process, etc.). Preforms are preferably, but not necessarily, substantially circular or oval in cross section. Applicant's use of the term “preform” explicitly excludes any size of shaped pieces of: (i) tape/ribbon, (ii) sheets of fiber, and (iii) laminates. The modifier “fiber-bundle-based” or “aligned-fiber” may be pre-pended herein to the word “preform” to emphasize the nature of applicant's preforms and to distinguish them from prior-art preforms, which are typically in the form of tape/ribbon, sheets, or shapes cut from sheets of fiber.
“Preform Charge” means an assemblage of preforms that are at least loosely bound together (i.e., tacked) to maintain their position relative to one another. Preform charges can contain fiber in form factors other than that of fiber bundles, and can contain various inserts, passive or active. Preform charges are not fully consolidated.
“Preform Layup” means an arrangement of individual preforms that is formed by placing preforms, one-by-one, into a mold cavity. A preform layup is distinguished from a preform charge, wherein for the latter, the preforms are at least loosely bound to one another and the assemblage thereof is usually formed outside of the mold cavity.
“Compatible” means, when used to refer to two different resin materials, that the two resins will mix and bond with one another.
“Compression molding” is a molding process that involves the application of heat and pressure to feed constituents. These constituents are typically placed in a female mold portion having a mold cavity. As the requisite amount of feed constituents are placed in the female mold portion, a second mold portion—a male mold portion—is joined to the female mold portion to close the mold cavity. The male mold portion usually includes features that extend into the female mold portion to engage the feed constituents therein. For applicant's processes, the pressure applied to the feed constituents is usually in the range of about 500 psi to about 5000 psi, and temperature, which is a function of the resin being used, is typically in the range of about 150° C. to about 400° C. Once the applied heat has increased the temperature of the resin above its melt temperature, it is no longer solid and will flow. The resin will then conform to the mold geometry via the applied pressure, and the feed constituents are thereby consolidated, resulting in a nascent part having very little void space. Elevated pressure and temperature are typically maintained for a few minutes. After this compression molding protocol is complete, the mold is cooled and removed from the source of pressure. A finished part is removed from the mold.
“Consolidate”, “consolidating”, or “consolidation” means, in the present context, that in a grouping of fibers/resin, such as plurality of preforms, void space is removed to the extent possible and as is acceptable for a final part. Feed structures lose any unique or individual identity and any previously existing boundaries between adjacent preforms are lost. This requires significantly elevated pressure, either through the use of gas pressurization (or vacuum), or the mechanical application of force (e.g., rollers, etc.), and elevated temperature (to soften/melt the resin).
“Partial consolidation” means, in the present context, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Neat” resin or other matrix material means that the resin/matrix material is devoid of reinforcing fibers.
“About” or “Substantially” means+/−20% with respect to a stated figure or nominal value.
Other definitions may be provided elsewhere in this specification, in context.

It is to be understood that any numerical range recited herein is intended to include all sub-ranges encompassed therein. For example, a range of “1 to 10” is intended to include all sub-ranges between (and including) the recited minimum value of about 1 and the recited maximum value of about 10, that is, having a minimum value equal to or greater than about 1 and a maximum value of equal to or less than about 10. As a non-limiting example, a recited range of “1 to 10 μm” includes “5 to 8 μm”, “1 to 4 μm”, “2 to 9 μm”, etc.

Feed Constituents. In accordance with the invention, an assemblage of preforms is positioned in a mold cavity. Preforms are typically formed from towpreg, but may also be sourced from the output of a resin impregnation line. To form a preform from towpreg or the output of a resin infusion line, the towpreg is cut into segments of a desired size and often shaped (e.g., bent, etc.) as well. Each preform include thousands of co-aligned, resin-infused fibers, typically in multiples of one thousand (e.g., 1k, 10k, 24k, etc.). A preform may have any suitable cross-sectional shape (e.g., circular, oval, trilobal, polygonal, etc.), but is most typically circular or oval.

As noted above, the fiber-bundle-based preforms are organized into an assemblage. The assemblage has a geometry and shape that is close to that of the part being fabricated, or a portion thereof (for example, in cases in which multiple assemblages of preforms are used). In some embodiments, the preforms are placed one-by-one into the mold, forming a “lay-up.” In some other embodiments, the preforms are first organized into a “preform charge.”

A preform charge includes a plurality of preforms that are “tacked” together. The term “tacking” references heating to the point of softening (but not melting) to effectively join the preforms to create a single structure. In some cases, minimal compression is applied for tacking. The preform charge, which is often created in a special fixture, conforms to the shape of the mold (and hence the part), or portions of it. Because the resin in the preforms is not heated to liquefication (the preforms are typically heated to a temperature that is above the heat deflection temperature of the resin, but below the melting point), and the applied pressure is typically low (less than 100 psi, and in some cases nothing more than the force of “gravity” acting on the preforms), the preform charge is not fully consolidated and thus could not function as a finished part. But once joined in this fashion, the preforms will not move, thereby maintaining the desired geometry and the specific alignment of each preform in the assemblage. See, e.g., Publ. Pat. Apps. US2020/0114596 and US2020/0361122.

As used herein, the term “assemblage of preforms” refers to either a lay-up of preforms, as formed by placing preforms one-by-one into a mold cavity, or to a preform charge.

As previously noted, a preform, as that term is used herein, is a bundle of resin-infused fibers. The individual fibers can have any diameter, which is typically, but not necessarily, in a range of 1 to 100 microns. The individual fibers can have any length, which is application specific, wherein the length results from the cutting operation that creates the associated preform. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of its composition, each individual fiber can be, for example and without limitation, carbon, carbon nanotubes, glass, natural fibers, aramid, boron, metal, ceramic, polymer, synthetic fibers, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Non-limiting examples of suitable synthetic fibers include nylon (polyamides), polyester, polypropylene, meta-aramid, para-aramid, polyphenylene sulfide, and rayon (regenerated cellulose).

Any resin—thermoplastic or thermoset—that bonds to itself under heat and/or pressure can be used in conjunction with embodiments of the invention.

Exemplary thermoplastic resins useful in conjunction with embodiments of the invention include, without limitation, acrylonitrile butadiene styrene (ABS), ethylene tetrafluoroethylene (ETFE), fluorinated ethylene propylene (FEP), liquid crystal polymers (LCPs), polyamides (Nylon), polyaryletherketones (PAEK), polybenzimidazole (PBI), polybutylene terephthalate (PBT), polycarbonates (PC), and polycarbonate-ABS (PC-ABS), polyethylene (PE), polyetheretherketone (PEEK), polyetherimide (PEI), polyether sulfones (PES), polyethylene terephthalate (PET), perfluoroalkoxy copolymer (PFA), polyimide (PI), polymethylmethacrylate (PMMA), polyoxymethylene (polyacetals) (POM), polypropylene (PP), polyphosphoric acid (PPA), polyphenylene ether (PPE), polyphenylene oxide (PPO), polyphenylene sulfide (PPS), polyphenylsulfone (PPSU), Polystyrene (PS), polysulfone (PSU), polytetrafluoroethylene (PTFE), polyurethane (PU), polyvinyl chloride (PVC), styrene acrylonitrile (SAN), and styrene butadiene styrene (SBS). A thermoplastic can be a thermoplastic elastomer such as polyurethane elastomer, polyether ester block copolymer, styrenic block copolymer, polyolefin elastomer, polyether block amide, thermoplastic olefins, elastomeric alloys (TPE and TPV), thermoplastic polyurethanes, thermoplastic copolyesters, thermoplastic polyamides, and thermoplastic silicone vulcanizate.

Non-limiting examples of suitable thermosets include araldite, bakelites, epoxies, melamines, phenol/formaldehydes, polyesters, polyhexahydrotriazines, polyimides, polyisocyanates, polyureas, silicones, urea/formaldehydes, vinyl esters, phenolics, and polycarbonates. Suitable thermosets can be prepared as a partially cured B-stage.

### EMBODIMENTS

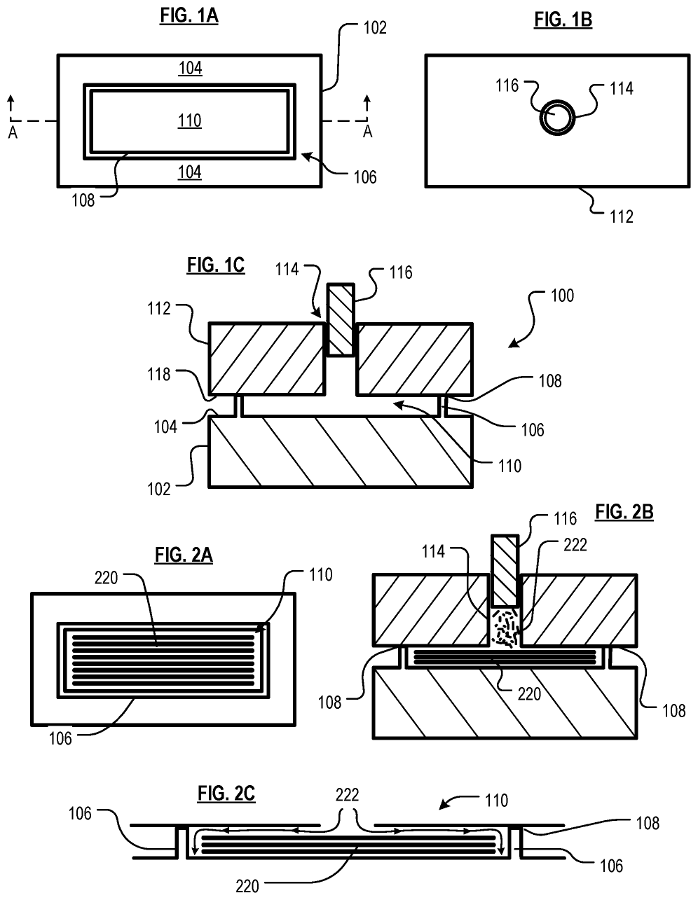

FIGS. 1A through 1C depict mold 100 in accordance with the present teachings. FIG. 1A depicts a top view of female mold portion or “B-side” 102 of mold 100 and FIG. 1B depicts a top view of male mold portion or “A-side” 112 of mold 100. FIG. 1C depicts a side cross-sectional view of mold 100 (both A-side and B-side shown) along the axis A-A of FIG. 1A in the direction indicated.

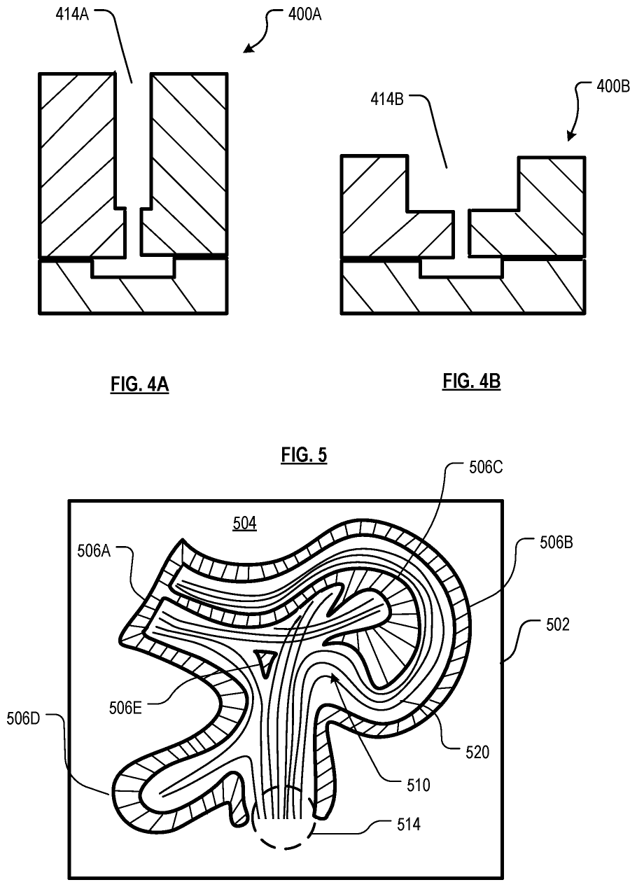

Female mold portion 102 includes wall 106, which, as best seen in FIG. 1C, extends upwardly from major surface 104, defining mold cavity 110. Male mold portion 112 includes plunger cavity 114, which receives plunger 116. When mold 100 is closed, a portion of major surface 118 of male mold portion rests on upper surface of wall 106. The surfaces that abut one another are referred to as “parting surfaces.” In FIG. 1A, the top of wall 106 is a parting surface—parting surface 108. There is a corresponding region on bottom 118 of male mold portion 112 that is a “parting surface” as well. It is notable that in most embodiments, wall 106 would be the inner wall of mold cavity 110, rather than a distinct, thin, perimeter wall as shown (for the purposes of illustrating the “parting surface”). See, for example, FIG. 3B. This provides a greater surface contact area, which permits more force to be applied to close the mold.

As can be seen from FIG. 1C, plunger cavity 114 extends fully through male mold portion 112 and communicates with mold cavity 110.

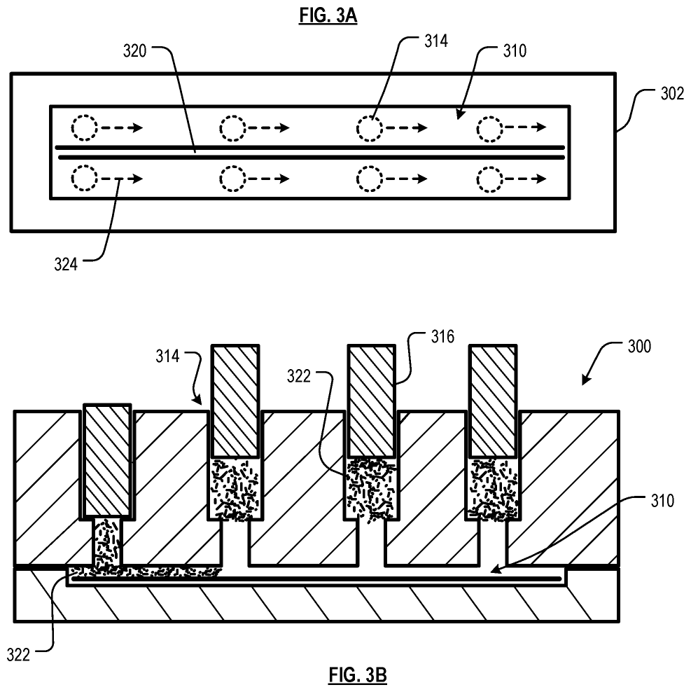

FIGS. 2A through 2C depict mold 100 in use in accordance with the present teachings. An assemblage of preforms 220 is disposed in mold cavity 110. The assemblage of preforms may be in the form of a “preform charge” or a “lay-up.” The volume of preforms 220 in the assemblage is insufficient to completely fill volume of mold cavity 110 when fully closed. Furthermore, as previously discussed, the “height” of the assemblage is no greater than the height available in the cavity of the fully closed mold tool (i.e., the final part height). The assemblage of preforms 220 will occupy a volume within the range of about 25 to 95 percent, and more typically about 50 to about 90 percent of the volume of fully closed mold cavity 110. The percentage of the volume of mold cavity 110 that is filled with preforms is dependent on any one or more of the following factors: material (fiber/resin) choice, optimal fiber alignment and/or placement, molding pressure and temperature, mold geometry, part size, injection charge volume and/or plunger volume, injection charge mass and/or plunger mass, thermal input energy, duration of individual processing steps and/or duration of the overall process, part structural requirements, and/or other considerations. Generally, the percentage fill is a tradeoff between part performance (e.g., strength, etc.) and part cosmetics. Relatively higher performance parts require a greater percentage of continuous fibers, whereas a part having a more stringent cosmetic requirement typically require a lower percentage of continuous fibers. Also, if cost is a consideration, a lower percentage of fibers is indicated.

As depicted in FIG. 2B, injection charge 222 is placed in plunger cavity 114. Injection charge 222 is neat resin (i.e., resin without fibers) or, alternatively, resin with fibers having a length less than 25 millimeters (mm), and preferably less than about 10 mm. In some embodiments, the fibers are “chopped fibers,” which have a length that is typically in the range of about 3 to about 10 mm. In some embodiments, the fibers are “milled fibers,” which typically have a length in the range of about 0.8 to 1.5 mm. The same resin is usually, but not necessarily, used in preforms 220 and injection charge 222. In some other embodiments, different resins are used for these two feed constituents, provided that the resins are compatible with one another.

In operation, and during the mold-closing process, force is applied to at least one of male mold portion 112 and female portion 102 mold, bringing these two portions into contact with one another. As noted above, the locations of contact between the portions of a mold are referred to as “parting surfaces” of the mold. For female mold portion 102, the parting surface is the upper surface of wall 106.

On the final part produced by the mold, a “parting line,” which is an undesirable cosmetic feature, typically appears at locations associated with parting surfaces. This is because there will necessarily be some small gap between abutting (i.e., parting) surfaces, such as due to surface imperfections, lack of parallelism between the abutting surfaces, etc. To minimize the gap at a parting surface, very high force is applied to close the mold. It is notable that this force results in a pressure on the parting surfaces that is considerably greater—as much as an order of magnitude—than the pressure at which the feed constituents are consolidated later in the process.

It is notable that by shutting the mold to seal the cavity (in accordance with embodiments of the invention) without compressing the assemblage of preforms (as in applicant's standard compression-molding processes), the fit tolerance between mold halves can be substantially tighter.

In standard process, since the male plunger (of the male mold portion) slides past the walls defining the mold cavity, the fit between the two must provide a gap—often referred to as a “shear gap”—to enable repeated relative motion without wear. The shear gap is generally in the range of about 0.5-0.1 mm.

In embodiments of the present invention, the tolerance between the two surfaces can be as tight as possible (i.e., within machining capability) since there is no wear surface. This enables the gap between them (parting line) to be much thinner via a high-tolerance fitment, in combination with a very high closing force.

Mold 100 is heated until at least the resin in injection charge 222 achieves its melt-flow state. Plunger 116 is then actuated, moving downwardly in plunger cavity 114. This advances liquefied injection charge 222 into mold cavity 110, filling any void space therein. Introduction of injection charge 222 pressurizes mold cavity 110, and the assemblage of preforms 220 therein, to a pressure in the range of about 1000 to 5000 psig, in accordance with applicant's compression molding protocols. If not already in its melt-flow state, the resin in the assemblage of preforms 220 achieves melt flow via the introduction of the injection charge into mold cavity 110. The applied pressure consolidates all the feed constituents; namely, the resin and fibers in preforms 220 as well as the resin (and short fibers if present) introduced as injection charge 222. After an appropriate dwell (typically a few minutes, but in some embodiments less than 1 minute) at elevated temperature (a function of the melt temperature of the resin(s)) and pressure, the mold is cooled, the pressure is released, and a finished part is demolded.

The arrows in FIG. 2C depict the flow of injection charge 222. The injection charge minimally penetrates the assemblage of preforms 220, remaining near the surface regions of the part being formed. Since injection charge 222 is either neat resin or resin containing short fibers, parts fabricated in accordance with the present teachings exhibit an improved surface finish relative to those produced from most conventional compression-molding processes.

Parts fabricated via conventional compression molding of relatively longer fibers (>25 mm in length) can experience issues related to parting lines, sink marks, exposed fibers, flash, or other surface defects due to shrinkage, pressure differential, and mold halves sliding relative to one another. More particularly, parting lines present cosmetic defects having a size that is typically in the range of about 10 to 150 microns, which can render a part unacceptable from a customer standpoint. Additionally, fibers might be exposed at the site of the parting lines after trimming thereof, or after trimming any flash remaining on the part.

Due to the reduced gap between tool surfaces in embodiments of the invention, flash and cosmetic defects are reduced. In embodiments of the invention, cosmetic defects from parting lines have a size of about 5 microns or less depending on parting-line machining tolerance. For many applications, such a defect size will be acceptable as is (no post processing), or with only minimal post processing. Consequently, a part formed in accordance with the present teachings will require less post processing than an equivalent part made via a conventional compression-molding process.

As previously described, the injection charge consists of neat resin (in the form of pellets) or resin with fibers (relatively “short” preform segments) that are less than 25 millimeters in length, and preferably less than 10 millimeters in length (such as chopped fibers), and most preferably consisting of milled fibers (typically 0.8 to 1.5 millimeters). To the extent that fibers are present in the injection charge, the resin and fiber can be separate, or in the form of resin-impregnated fiber. The relatively shorter fibers in the injection charge result in less wear on a molding tool than relatively longer fibers. This is because short fibers move more readily relative to one another than long fibers when pressed against a mold surface. Such movement reduces the tendency for abrasion of tool surfaces.

In some embodiments, plunger(s) are strategically placed to either promote or discourage the flow of fibers from the assemblage of preforms 220 as the injection charge is introduced into the mold cavity. Consider that the greater the length of a fiber, the more resistant it is to displacement due to shear forces resulting from viscous flow of resin. Thus, in some embodiments, it is desirable to position the plunger cavity/plunger at a location relatively distant from preforms 220 having fibers with a length less than about 40 millimeters, because such fibers are otherwise likely to be displaced from their initial placement location (i.e., they will flow) due to the viscous flow of injection charge 222. Of course, to promote the flow of such fibers, a plunger(s) is situated relatively near to them, enabling such fibers to directed to a desired final location or desired orientation by virtue of the viscous flow of the injection charge. Moreover, the injection charge flow can, to a limited extent, align relatively long fibers (greater than 40 mm) with the flow direction of the injection charge.

Embodiments of the invention are particularly well suited to providing high-performance, high-aspect ratio parts for which flash or significant parting lines are unacceptable. Once such part is an airfoil, wherein parting lines tend to occur at the leading and trailing edges of the airfoil. These parting lines and occurrences of flash can produce disturbances to air flow that dramatically degrade the performance of the airfoil by decreasing lift and increasing drag. Embodiments of the invention enable the precise alignment of reinforcing fibers extending the full length of the airfoil without discontinuities and without deviating from the principal stress vectors expected to arise in the part while in use.

FIGS. 3A and 3B depict a further embodiment in accordance with the present teachings. FIG. 3B depicts a side cross-sectional view of mold 300, which includes eight plungers, organized in four pairs. FIG. 3A depicts a top view of female mold portion 302 of mold 300.

An assemblage of preforms 320 is situated along the longitudinal centerline of mold cavity 310 of mold 300. For the purposes of this example, minimal movement or reorientation of preforms 320 is desired. If a single plunger were used to introduce the full volume of the injection charge—at either end of the mold cavity or near its center—it would be difficult to prevent movement or reorientation of the preforms due to the viscous flow of the injection charge. By introducing the requisite amount of injection charge through plural—in this case eight—plunger cavities 314, the (reduced) flow emanating from each plunger cavity is far less likely to disturb preforms 320.

Arrows 324 in FIG. 3A depict the primary flow path of injection charges 322 in a scenario in which pairs of plungers are sequentially activated, from left to right. The leftmost pair of plungers is activated first and delivers its injection charge 322, followed by the middle-left pair, then the middle-right pair, and finally the rightmost pair. This creates a flow vector from left to right, and, as a consequence of distributing the injection charge across multiple plunger cavities, decreases the likelihood that preforms 320 along the centerline of mold cavity 310 are disturbed from their initial position.

The four pairs of plungers can be individually actuated or can be activated by a single actuator. A single actuator can be implemented as a beam, etc. (not depicted), which is disposed parallel to the top of mold 300 and which couples to each plunger 316. Downward force on the beam causes all plungers 316 to advance into their respective plunger cavity 314.

Utilizing multiple plungers enables a high degree of control over the finished part. For example, if the assemblage of preforms include preforms having fibers less than about 40 mm in length (which can flow with the liquefied resin assuming that they are small relative to portion of the mold cavity in which they reside; that is, they are not continuous fibers), the injection charge can be used to facilitate the flow of such fibers to a desired location in the mold cavity (e.g., to the site of a small feature, etc.). Thus, by consideration of plunger-cavity location, and plunger execution time, appropriately sized fibers can be guided to any desired location in the mold cavity. In fact, given a set of positions for the plunger cavities, a different injection sequence can result in drastically different fiber alignments in a part. This method can be used to guide fibers in arbitrary location in the volume of the mold cavity; that is, the method can direct fibers in any one or more X, Y, and/or Z directions.

Additionally, multiple plungers can be used to introduce the injection charge to alter/control the orientation of the fibers sourced from the assemblage of preforms that are too long to flow from one location to another. That is, the injection charge can alter the shape/location of portions of such (non-flowing) fibers.

Also, the use of multiple plungers improves thermal distribution and reduces instances of uneven heating throughout the mold cavity. And having multiple plungers reduces the size of individual plungers, which reduces the likelihood of damage to the mold during processing.

FIGS. 4A and 4B depict two molds 400A and 400B with different plunger-cavity geometries. For a given volume of injection charge, the plunger cavity can be relatively longer and narrower, or relatively shorter and wider. Plunger cavity 414A of mold 400A is an example of the former, and plunger cavity 414B of mold 400B is an example of the latter. Reducing plunger-cavity height (and plunger height) may reduce the overall mass of the portion of the mold containing the injection cavity. Reducing such mass reduces heating energy requirements as well as the time it takes to heat that portion of the mold (and hence the injection charge). Additionally, reducing the height of the plunger-cavity reduces the travel of the plunger. This reduces the likelihood of tool damage due to tolerancing or parallelism issues.

FIG. 5 depicts, via a plan view, a complex mold cavity 510 of female mold portion 502. Mold cavity 510 is defined by walls 506A, 506B, 506C, 506D, and 506E rising from upper surface 504. An assemblage of preforms 520 is disposed in the mold cavity. As shown, the part being molded requires a complex, multi-branching assemblage of preforms 520. This embodiment uses a single plunger cavity 514 for delivering injection charge.

Because the required orientation of preforms is winding, overlapping, and complex, there are no conventional processes that can achieve the desired fiber alignment with the benefits of reduced flash, improved surface finish, etc., as is possible with embodiments of the invention.

To create a part from the mold depicted in FIG. 5, preforms 520 are placed in mold cavity 510 to form the assemblage shown, with a desired fill percentage, which in this embodiment is 90 (volume) percent of mold cavity 510. In some embodiments, preforms 520 consist of glass fiber impregnated with polycarbonate resin. In some of such embodiments, the injection charge consists of polycarbonate resin with chopped glass fibers having a length, on average, of less than 25 millimeters.

A male mold portion (not depicted) is brought together with female mold portion 502 to close the mold with a minimal gap between parting surfaces located on upper surface of walls 506A, 506B, 506C, 506D, and 506E. The mold and injection cavity 514 are heated until the polycarbonate resin in both the preforms and the injection charge (not depicted) reaches its melt phase. A plunger, not depicted, is then depressed to inject the injection charge into mold cavity 510. As previously described, the flow of the liquified injection charge tends to remain near the surface region of the part being formed.

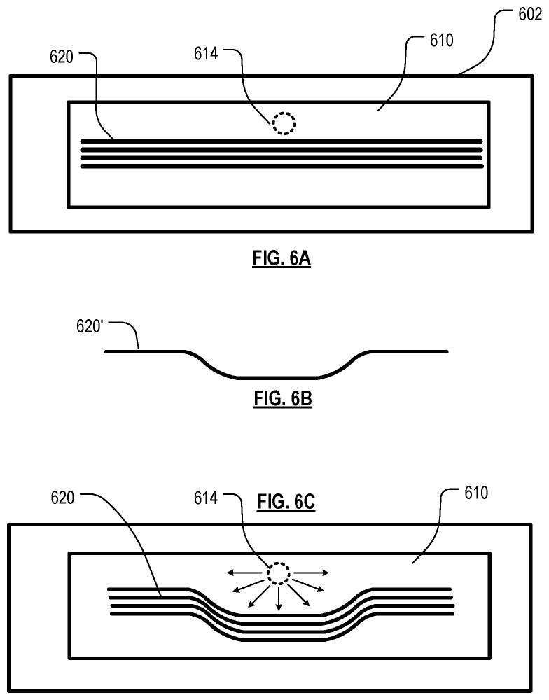

FIGS. 6A-6C depict an embodiment wherein the plunger/plunger cavity is sited at a location such that the introduction of the injection charge can manipulate the alignment of the preforms within the mold cavity.

FIG. 6A depicts female mold portion 602 having mold cavity 610. An assemblage of preforms 620 is disposed in the mold cavity. In the embodiment depicted in FIG. 6A, plunger cavity 614 and plunger (located in a male mold portion that is not depicted) are positioned near the midpoint of mold cavity 610, closer to one side thereof. It was determined (e.g., from FEA analysis, etc.) that the part being formed optimally includes some preforms 620′ shaped as depicted in FIG. 6B. However, the assemblage of preforms 620 used in this example includes only linear preforms. After mold closure and heating to liquefy the injection charge, the plunger (not depicted) is actuated to introduce the injection charge (not depicted) into mold cavity 610.

As depicted in FIG. 6C, the viscous flow of the injection charge, indicated by the arrows extending from the (bottom) of plunger cavity 614, pushes the middle portion of nearby preforms away from the injection-charge introduction site. The distal ends of the affected preforms 620 are otherwise unaffected. This produces the desired preform shape shown in FIG. 6B, but does so using straight preforms rather than bent preforms. Pre-bending preforms, as would otherwise be required, involves additional time and cost, and reduces overall process efficiency. In accordance with some embodiments of the invention, bending the preforms in-situ by virtue of the injection charge, eliminates the extra processing (pre-bending) step, providing time and cost savings, and improving overall process efficiency.

In some embodiments of the method depicted in FIGS. 6A-6C, preforms 620 are softened, but not liquefied, prior to the introduction of the injection charge. This can be achieved by selective heating, wherein the mold cavity or injection plunger/cavity are heated separately so that most of the heating is localized to one part of the mold tool or another. Alternatively, preforms 620 and the injection charge can include different resins having different melt temperatures.

In some embodiments, the resin in the preforms of the assemblage have a lower melt temperature than the resin in the injection charge. In such embodiments, it is desirable to localize the application of heat to the plunger and injection cavity to the extent possible to prevent the overheating of the preforms in the mold cavity. This can be accomplished because a compression mold in accordance with the present teachings enables a great deal of control over the location and size of the injection cavity and plunger.

It is to be understood that the disclosure describes a few embodiments and that many variations of the invention can easily be devised by those skilled in the art after reading this disclosure and that the scope of the present invention is to be determined by the following claims.

What is claimed:

1. An injection/compression-molding method for forming a part, the method comprising:
placing an assemblage of fiber-bundle-based preforms in a mold cavity of a female mold portion of a mold tool, each fiber-bundle-based preform consisting essentially of a first resin and a plurality of fibers, wherein a volume of the assemblage is less than a volume of the mold cavity when the mold tool is fully closed, a void volume therefore remaining, and wherein a height of the assemblage is no greater than a height of the cavity of the fully closed mold tool;
placing an injection charge in a first plunger cavity that is in fluidic communication with the mold cavity, the injection charge consisting essentially of a second resin with or without fibers, wherein any fibers in the injection charge are less than about 25 millimeters in length and less than a length of the fibers in the fiber-bundle-based preforms;
closing the mold cavity, thereby placing a male mold portion and the female mold portion into abutting relation;
liquefying the second resin;
introducing the injection charge into the mold cavity by advancing a first plunger in the first plunger cavity, the injection charge filling the void volume, thereby pressurizing the mold cavity, wherein the mold cavity is pressurized to a pressure suitable for compression molding;
liquefying the first resin, wherein the pressure applied by the injection charge consolidates the first resin, the second resin, the plurality of fibers from the fiber-bundle-based preforms, and the fibers, if present, from the injection charge, collectively referenced as the “molding constituents”; and
after a period of time, cooling the consolidated molding constituents to form the part.

2. The injection/compression-molding method of claim 1 wherein the volume of the assemblage of preforms is between about 50 to 90 volume percent of the mold cavity.

3. The injection/compression-molding method of claim 1 wherein the pressure suitable for compression molding is in a range of about 1000 to about 5000 psi.

4. The injection/compression-molding method of claim 1 wherein first resin and the second resin are liquefied at the same time.

5. The injection/compression-molding method of claim 1 wherein the injection charge consists of the second resin and fibers having a length of less than about 10 millimeters.

6. The injection/compression-molding method of claim 1 wherein the injection charge consists of the second resin and milled fiber.

7. The injection/compression-molding method of claim 1 comprising:
placing a first portion of the injection charge in the first plunger cavity and a second portion of the injection charge in a second plunger cavity that is in fluidic communication with the mold cavity; and, after closing the mold cavity and liquefying the second resin,
introducing the first portion of the injection charge into the mold cavity by advancing the first plunger in the first plunger cavity; and, after introducing at least some of the first portion of the injection charge into the mold cavity,
introducing the second portion of the injection charge into the mold cavity by advancing a second plunger in the second plunger cavity.

8. The injection/compression-molding method of claim 1 comprising introducing all of the first portion of the injection charge before introducing the second portion of the injection charge into the mold cavity.

9. The injection/compression-molding method of claim 1 comprising:
placing a first portion of the injection charge in the first plunger cavity and a second portion of the injection charge in a second plunger cavity that is in fluidic communication with the mold cavity; and, after closing the mold cavity and liquefying the second resin,
introducing the first portion and the second portion of the injection charge into the mold cavity at the same time.

10. The injection/compression-molding method of claim 1 wherein at least some of the fiber-bundle-based preforms and the fibers therein are linear, the method comprising introducing the injection charge into the mold cavity at a location that deforms the linear fibers to a predetermined shape that more closely aligns the deformed fibers, than the linear fibers, with stress vectors expected to arise in the part being formed when the part is in use.

11. An injection/compression-molding method for forming a part, the method comprising:
closing, but not pressurizing, a mold tool that contains, in a mold cavity, an assemblage of fiber-bundle-based preforms, each preform comprising a first resin and a plurality of fibers, wherein a volume of the assemblage is less than a volume of the mold cavity when the mold tool is fully closed, a void volume therefore remaining, and wherein a height of the assemblage is no greater than a height of the cavity of the fully closed mold tool;
liquefying an injection charge that is disposed in a first plunger cavity that is in fluidic communication with the mold cavity, the injection charge comprising a second resin;
pressurizing the mold cavity to a pressure suitable for compression molding by introducing the liquefied injection charge into the fully closed mold tool;
liquefying the first resin and consolidating the first resin, the second resin, and the plurality of fibers via the pressure applied by the injection charge; and
after a period of time, cooling and depressurizing to form the part.

12. The injection/compression-molding method of claim 11 wherein the volume of the assemblage of preforms is between about 50 to 95 volume percent of the mold cavity.

13. The injection/compression-molding method of claim 11 wherein the pressure suitable for compression molding is in a range of about 1000 to about 5000 psi.

14. The injection/compression-molding method of claim 11 wherein first resin and the second resin are liquefied at the same time.

15. The injection/compression-molding method of claim 11 wherein the injection charge consists of the second resin and fibers having a length of less than about 25 millimeters.

16. The injection/compression-molding method of claim 11 wherein the injection charge consists of the second resin and fibers having a length of less than about 10 millimeters.

17. The injection/compression-molding method of claim 11 wherein liquefying the injection charge comprises:
disposing a first portion of the injection charge in the first plunger cavity and a second portion of the injection charge in a second plunger cavity that is in fluidic communication with the mold cavity.

18. The injection/compression-molding method of claim 17 wherein pressurizing the mold cavity comprises:
introducing the first portion of the injection charge into the mold cavity; and
after introducing at least some of the first portion of the injection charge into the mold cavity, introducing the second portion of the injection charge into the mold cavity.

19. The injection/compression-molding method of claim 17 comprising introducing the first portion and the second portion of the injection charge into the mold cavity at the same time.

20. The injection/compression-molding method of claim 11 wherein at least some of the fiber-bundle-based preforms and the fibers therein are linear, the method comprising: pressurizing the mold cavity to a pressure suitable for compression molding by introducing the liquefied injection charge into the mold cavity at a location that deforms the linear fibers to a predetermined shape that more closely aligns the deformed fibers, than the linear fibers, with stress vectors expected to arise in the part being formed when the part is in use.
